(19) United States
(12) Patent Application Publication
(10) Pub. No.: US 2005/0147853 A1
(43) Pub. Date: Jul. 7, 2005

(54) Method of operating a fuel cell with fuel recirculation

(76) Inventors: Lars Kaufmann, Alfter (DE); Gerhard Konrad, Ulm (DE); Arnold Lamm, Elchingen (DE)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/503,182

(22) PCT Filed: Jan. 31, 2003
(86) PCT No.: PCT/EP03/00969

(30) Foreign Application Priority Data
Feb. 1, 2002 (DE) 10204124.5

(51) Int. Cl. H01M 8/04

(52) U.S. Cl. 429/13; 429/22; 429/24

(57) ABSTRACT

In a method of operating a fuel cell with fuel circulation, the recirculated moist fuel exhaust stream serves to humidify the fuel inlet stream. The fuel stoichiometry and operating temperatures may be adjusted or selected to control the humidity of the fuel inlet stream.

### CROSS-REFERENCE TO RELATED APPLICATION

This application claims priority to German Application No. 10204124.5, filed Feb. 1, 2002, which priority application is incorporated herein by reference in its entirety.

### BACKGROUND OF THE INVENTION

The present methods relate to the humidification of hydrogen gas to be used in a fuel cell, and in particular, a solid polymer (PEM) fuel cell.

The operation of fuel cells with pure hydrogen, including the recirculation of hydrogen are known. For example, U.S. Pat. No. 6,117,577 describes a design in which hydrogen supplied to the anode of a fuel cell is recirculated. In this case, the recirculation apparatus includes a water separator, which in turn feeds a humidification and cooling system, and further includes a compressor to compensate for pressure drops occurring in the fuel cell itself and the anode of the fuel cell.

Also known in the prior art are designs in which a jet pump or similar device takes the place of the compressor, which requires a very high hydrogen inlet pressure, but if hydrogen pressure tanks are used, then a high inlet pressure is already available.

In addition, U.S. Pat. No. 5,200,278 describes a design in which hydrogen is recirculated in a similar manner and is supplied to the intake for the anode. This design also uses a compressor or similar device and includes the separation of liquid constituents that are present in the hydrogen.

A further design of the above-mentioned type is described in WO 00/63993, which shows an auxiliary power unit (APU) with a solid polymer fuel cell, in which the hydrogen is recirculated in order to make it possible to consume all of the available hydrogen.

According to the above-mentioned publications, liquid water is fed into the membrane areas for the purpose of humidifying and cooling the fuel cells and the membranes of the fuel cells. Subsequently, this water is discharged via the exhaust gases of the cathode and the anode, together with product water.

However, this design is complicated, since it requires special humidifying systems. There remains a need for a method that does not require a separate humidification step or apparatus.

### BRIEF SUMMARY OF THE INVENTION

In the present methods, the fuel is preferably supplied at a higher than normal stoichiometry. This makes a comparatively large amount of gas available for recirculation, due to the larger (excess) quantity of hydrogen that is supplied to the anode. This comparatively large amount of gas is able to absorb and transport moisture, which reaches the anode area due to the difference in partial pressures. This fuel exhaust gas that is present downstream of the anode, together with the moisture contained in the gas, is recirculated to the hydrogen feed stream to the anode by means of a recirculation device, such as a hydrogen recirculation fan or pump. The mixing of the dry hydrogen gas with the recirculated moist hydrogen gas results in a dew point of for example 70° C., in one embodiment in the range of 40° C.-70° C., which ensures adequate humidification of the anode side of the fuel cell membrane.

In one aspect, the present methods may enable operation so that no additional water is required for membrane humidification, such that the need for related apparatus, such as for example humidifiers and similar devices, is eliminated.

These and other aspects will be evident upon reference to the attached Figures and following detailed description.

### BRIEF DESCRIPTION OF THE DRAWINGS

FIG. 1 is a schematic view of one embodiment of the present methods.

FIG. 2 is a graph showing the amount of additional water that is required to humidify the hydrogen gas as a function of the ratio of the hydrogen supplied to the anode chamber to the hydrogen consumed in the anode, at constant pressure, for various gas temperatures at the anode chamber outlet.

### DETAILED DESCRIPTION OF THE INVENTION

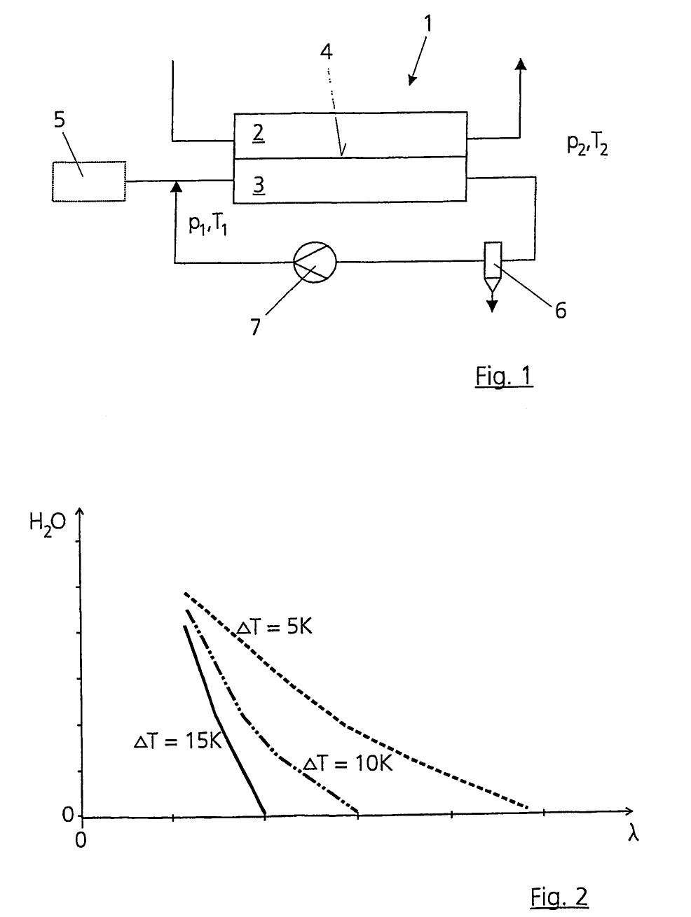

FIG. 1 shows a fuel cell 1 with a cathode 2 and an anode 3, which are separated by a proton-conducting membrane 4. The operation of fuel cell 1 is known in the art and accordingly will not be explained in detail. Ambient air reaches cathode 2 as indicated. In the fuel cell, air and hydrogen are converted to electrical energy and water.

The hydrogen originates from a hydrogen source 5, shown in the figure with dotted lines. Hydrogen source 5 may for example be a hydrogen tank. For example, pressure tanks or metal hydride storage can be used as hydrogen source 5. It is also possible for the hydrogen to originate from a gas generation system or fuel processing system, which produces a hydrogen-rich gas through reforming. In such a case, suitable purification devices are required to remove from the hydrogen stream substances that cannot be converted in fuel cell 1, i.e. CO₂, residues of the reformer source material, inert gases, etc. The nature of hydrogen source 5 is not material to the present methods. All that is required is that hydrogen is made available to fuel cell 1, where, together with oxygen, it is converted to water and electrical energy.

Hydrogen at a pressure p₁ and a temperature T₁ is provided to anode 3, where it is partially converted to electric current and water together with the oxygen originating in cathode 2. Subsequently, the residual unreacted hydrogen is discharged from anode 3 at a temperature T₂ and a pressure p₂. Pressure p₂ is slightly lower than pressure p₁ due to the pressure drop across anode 3.

One aspect of the present methods is that the volumetric flow rate of hydrogen reaching anode 3 is larger than the amount of hydrogen converted in anode 3. The ratio of hydrogen supplied to the anode to hydrogen converted at anode 3 is referred to as the stoichiometric ratio, λ. In accordance with the present methods, this stoichiometric ratio is significantly larger than 1, making it possible to recirculate the hydrogen gas. For this purpose, the hydrogen gas is returned to the anode inlet pipe via a liquid separator 6 and a recirculation device 7, such as a fan. Recirculation device 7 increases the pressure of the recirculated hydrogen exhaust stream to compensate for the pressure drop across anode 3, the subsequent line elements, and liquid separator 6.

The typical pressure levels in the illustrated embodiment are very low. For example, the hydrogen supply pressure p₁ may be approximately 5 bar absolute, preferably between 1.5 to 5 bar of absolute pressure, in which case recirculation device 7 depending on the fuel cell would typically have to compensate for pressure drops on the order of several hundred mbar. For high-pressure applications, i.e. where pressure p₁ is significantly higher than 5 bar, e.g. 10 or 15 bar, the present methods may be employed, however the energetic benefits may not be as significant as in a low-pressure system or a system that operates at a pressure that is only several hundred mbar higher than ambient pressure.

Hydrogen supplied to anode 3 is typically humidified. The illustrated embodiment does not require any separate humidification component, such as a humidifier, in which water and hydrogen are brought into direct or indirect contact with each other. During the operation of fuel cell 1, a certain amount of product water accumulates in the hydrogen gas flowing through anode 3. Subsequently, the hydrogen gas can return this moisture to the anode through the recirculation system and make it available to the hydrogen gas entering anode 3. After a start-up phase is complete, a saturation state is reached, so that the hydrogen gas will be at its dew point. Consequently, when the hydrogen gas leaves anode 3, it will carry a comparably large quantity of water vapor and possibly liquid water, due to the fact that the outlet temperature T₂ is typically higher than the inlet temperature T₁.

As the hydrogen gas passes through liquid separator 6, liquid water present in is the hydrogen gas is removed from the stream. The remaining hydrogen gas—containing water vapour—is then mixed with the hydrogen from hydrogen source 5. The humidity of the hydrogen gas entering anode 3 will depend on the set the stoichiometric ratio, λ, and the operating temperature T₁.

If, for example, temperature T₁ is approximately 60° to 80° C. and temperature T₂ is 5 to 15 K higher, then λ can be set so that a particular dew point is reached at pressure p₁ and temperature T₁, so that water does not need to be added for humidification.

The purpose of FIG. 2 is to illustrate this point, where the goal is to keep the gas supplied to anode 3 at its dew point at temperature T₁. The figure shows the amount of water that must be supplied from external sources to meet this objective depending on λ. The three curves shown are for temperature differences ΔT=T₂−T₁ between 5 and 15 K.

The three curves show that as the temperature difference increases, reaching the point where no additional water is needed requires a smaller and smaller λ. In the described embodiments, λ is between approximately 1.5 and 5. A ΔT of 5 K or 10 K may be considered for practical applications, since the λ required for such a temperature difference will be on the order of 1.5 to 3.5 which can be realized without difficulty in a system of the type illustrated.

Using the present methods, if for example the system is operated according to the solid line for ΔT=15 K, it can be ensured—given a sufficiently high λ—that the anode side of membrane 4 can be humidified without having to resort to humidification of the hydrogen using water supplied from external sources, which would require a corresponding humidification system.

Moreover, it is clearly also possible to manage without a system for recovering as much water as possible from the anode exhaust gas in order to keep the system self-sufficient with respect to its water supply, e.g. a condenser or similar device. The water condensing at the respective dew points is carried in liquid form in the recirculation system and can easily be removed by liquid separator 6, which represents a minimal expense and offers little complexity with respect to hardware and space requirements.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A method of operating a solid polymer fuel cell, comprising:
supplying an inlet fuel stream comprising hydrogen to a fuel cell inlet;
recirculating at least a portion of an exhaust fuel stream exhaust from a fuel cell outlet to the fuel cell inlet;
wherein the humidity of the inlet fuel stream is adjusted by controlling the fuel stoichiometry.

2. The method of claim 1, wherein the fuel stoichiometry is selected based on a temperature difference between the fuel cell inlet and the fuel cell outlet.

3. The method of claim 2, wherein controlling the fuel stoichiometry comprises adjusting a recirculation device disposed between the fuel cell inlet and the fuel cell inlet based on the temperature difference.

4. The method of claim 1, wherein the fuel stoichiometry is selected based on a temperature difference between the inlet fuel stream and the exhaust fuel stream.

5. The method of claim 4, wherein the fuel stoichiometry is decreased as the temperature difference increases.

6. The method of claim 1, wherein the fuel stoichiometry is controlled so as to maintain the inlet fuel stream at its dew point.

7. The method of claim 6, wherein the temperature of the inlet fuel stream is in the range of about 40 to 80° C. and the pressure of the inlet fuel stream is in the range of about 2 to 4 bar absolute.

8. The method of claim 7, wherein the temperature of the inlet fuel stream is in the range of about 60 to 80° C.

9. The method of claim 1, wherein substantially all of the exhaust fuel stream is recirculated.

10. The method of claim 1, further comprising separating liquid water from the exhaust fuel stream prior to recirculating the exhaust fuel stream to the fuel cell inlet.

11. The method of claim 1, wherein the inlet fuel stream is humidified only by means of the recirculated exhaust fuel stream.

12. The method of claim 1, wherein controlling the fuel stoichiometry comprises adjusting a recirculation device disposed between the fuel cell inlet and the fuel cell inlet based on a fuel cell outlet temperature.

13. The method of claim 1, wherein the fuel stoichiometry is greater than 1.5.

14. The method of claim 1, wherein the pressure of the inlet fuel stream is not greater than about 5 bar absolute.
